(19) United States
(12) Patent Application Publication
(10) Pub. No.: US 2022/0222595 A1
(43) Pub. Date: Jul. 14, 2022

(54) DATA FEATURE DETERMINING METHOD AND APPARATUS, AND ELECTRONIC DEVICE

(71) Applicant: Shanghai IceKredit, Inc., Shanghai (CN)

(72) Inventors: Lingyun GU, Shanghai (CN); Minqi XIE, Shanghai (CN); Wan DUAN, Shanghai (CN); Tao ZHANG, Shanghai (CN); Jun PAN, Shanghai (CN); Shangwei CHEN, Shanghai (CN)

(73) Assignee: Shanghai IceKredit, Inc., Shanghai (CN)

(21) Appl. No.: 17/462,031

(22) Filed: Aug. 31, 2021

(30) Foreign Application Priority Data
Jan. 14, 2021 (CN) 202110045213.6

(51) Int. Cl. G06Q 10/06; G06N 20/00

(52) U.S. Cl. CPC G06Q 10/067; G06N 20/00

(57) ABSTRACT

A data feature determining method includes: obtaining a to-be-processed data set; setting an initial selected feature set and an initial excluded feature set, and determining a candidate feature set; setting a maximum quantity of input model variables, a VIF threshold, and a minimum increment threshold of an AUC indicator of a model; traversing the candidate feature set to obtain a current-round traversal result; determining a maximum AUC value in the current-round traversal result, and determining whether a difference between the maximum AUC value in the current-round traversal result and a maximum AUC value in a previous-round traversal result is greater than the minimum increment threshold; if yes, removing a target feature based on the maximum quantity of the input model variables, and using the features in the selected feature set as the final data features; and if no, using the features in the selected feature set as the final data features.

### CROSS REFERENCE TO THE RELATED APPLICATIONS

This application is based upon and claims priority to Chinese Patent Application No. 202110045213.6, filed on Jan. 14, 2021, the entire contents of which are incorporated herein by reference.

### TECHNICAL FIELD

The present invention relates to the technical field of data feature processing, and more particularly, to a data feature determining method and apparatus, and an electronic device.

### BACKGROUND

User data has many features in existing business scenarios (such as credit and loan scenarios). Feature selection is not only conducive to filtering out redundant and invalid features, but also conducive to improving an effect of model prediction. There are two kinds of methods for performing feature selection on the user data. The first method is business-based manual feature selection, which is usually used by technicians to manually delete some features with poor performance in combination with relevant knowledge and experience of credit and loan businesses. The second method is logistic regression-based forward or backward feature selection.

In the first method, there is a high business requirement for the technicians, and feature selection needs to be performed manually. As a result, such a method has a low efficiency and an unstable effect, and often causes misjudgment, that is, a feature with good performance is deleted, or a feature with poor performance is retained.

In the logistic regression-based forward feature selection, all remaining features need to be combined with a selected feature one by one to train a model in each round, resulting in high time complexity in calculation. In addition, an added feature may be related to some of the selected features and thus form multicollinearity, which results in feature redundancy. Disadvantages of backward feature selection are basically the same as those of forward feature selection.

### SUMMARY

To resolve the above problems, the present invention provides a data feature determining method and apparatus, and an electronic device.

According to a first aspect, a data feature determining method is provided, where the method is applied to an electronic device, and includes the following steps:

obtaining a to-be-processed data set;

setting an initial selected feature set and an initial excluded feature set, and determining a candidate feature set based on an initial data feature set of the to-be-processed data set, the selected feature set and the excluded feature set;

setting a maximum quantity of input model variables, a variance inflation factor (VIF) threshold, and a minimum increment threshold of an area under curve (AUC) indicator of a model;

traversing the candidate feature set to obtain a current-round traversal result;

determining a maximum AUC value in the current-round traversal result, and determining whether a difference between the maximum AUC value in the current-round traversal result and a maximum AUC value in a previous-round traversal result is greater than the minimum increment threshold;

if the difference between the maximum AUC value in the current-round traversal result and the maximum AUC value in the previous-round traversal result is greater than the minimum increment threshold, adding a target feature corresponding to the maximum AUC value in the current-round traversal result to the selected feature set and removing the target feature from the candidate feature set; returning to the step of traversing the candidate feature set to obtain the current-round traversal result until a quantity of features in the selected feature set reaches the maximum quantity of the input model variables; and then using the features in the selected feature set as final data features; and

if the difference between the maximum AUC value in the current-round traversal result and the maximum AUC value in the previous-round traversal result is less than or equal to the minimum increment threshold, using the features in the selected feature set as the final data features.

Optionally, the method further includes: training and predicting a target model by using the final data features.

Optionally, the step of determining the candidate feature set based on the initial data feature set of the to-be-processed data set, the selected feature set and the excluded feature set includes:

deleting the selected feature set and the excluded feature set from the initial data feature set to obtain the candidate feature set.

Optionally, the step of traversing the candidate feature set to obtain the current-round traversal result includes:

selecting one to-be-processed feature from the candidate feature set each time, combining the to-be-processed feature and the selected feature set, and constructing a logistic regression model;

performing five-fold cross validation on the initial data feature set by using the logistic regression model, and recording an average AUC value and a maximum VIF value that correspond to the to-be-processed feature in five cross validations performed by using the constructed logistic regression model;

if the maximum VIF value corresponding to the to-be-processed feature is greater than the VIF threshold, deleting the to-be-processed feature from the candidate feature set; and

if the maximum VIF value corresponding to the to-be-processed feature is less than or equal to the VIF threshold, retaining the to-be-processed feature.

According to a second aspect, a data feature determining apparatus is provided, where the apparatus is applied to an electronic device, and includes the following modules:

a data acquisition module, configured to obtain a to-be-processed data set;

a feature determining module, configured to set an initial selected feature set and an initial excluded feature set, and determine a candidate feature set based on an initial data feature set of the to-be-processed data set, the selected feature set and the excluded feature set;

a variable setting module, configured to set a maximum quantity of input model variables, a VIF threshold, and a minimum increment threshold of an AUC indicator of a model;

a feature traversal module, configured to traverse the candidate feature set to obtain a current-round traversal result; and

a feature selection module, configured to: determine a maximum AUC value in the current-round traversal result, and determine whether a difference between the maximum AUC value in the current-round traversal result and a maximum AUC value in a previous-round traversal result is greater than the minimum increment threshold;

if the difference between the maximum AUC value in the current-round traversal result and the maximum AUC value in the previous-round traversal result is greater than the minimum increment threshold, add a target feature corresponding to the maximum AUC value in the current-round traversal result to the selected feature set and remove the target feature from the candidate feature set; return to traverse the candidate feature set to obtain the current-round traversal result until a quantity of features in the selected feature set reaches the maximum quantity of the input model variables; and then use the features in the selected feature set as final data features; and

if the difference between the maximum AUC value in the current-round traversal result and the maximum AUC value in the previous-round traversal result is less than or equal to the minimum increment threshold, use the features in the selected feature set as the final data features.

Optionally, the apparatus further includes: a model training module, configured to train and predict a target model by using the final data features.

Optionally, when the feature determining module determines the candidate feature set based on the initial data feature set of the to-be-processed data set, the selected feature set and the excluded feature set, the feature determining module is specifically configured to:

delete the selected feature set and the excluded feature set from the initial data feature set to obtain the candidate feature set.

Optionally, when the feature traversal module traverses the candidate feature set to obtain the current-round traversal result, the feature traversal module is specifically configured to:

select one to-be-processed feature from the candidate feature set each time, combine the to-be-processed feature and the selected feature set, and construct a logistic regression model;

perform five-fold cross validation on the initial data feature set by using the logistic regression model, and record an average AUC value and a maximum VIF value that correspond to the to-be-processed feature in five cross validations performed by using the constructed logistic regression model;

if the maximum VIF value corresponding to the to-be-processed feature is greater than the VIF threshold, delete the to-be-processed feature from the candidate feature set; and

if the maximum VIF value corresponding to the to-be-processed feature is less than or equal to the VIF threshold, retain the to-be-processed feature.

According to a third aspect, an electronic device is provided, including a processor and a memory, where the processor and the memory communicate with each other, and the processor is configured to obtain a computer program from the memory and run the computer program to implement the method in the first aspect.

According to a fourth aspect, a computer-readable storage medium is provided, where a computer program is stored on the computer-readable storage medium, and the computer program is configured to be run to implement the method in the first aspect.

The embodiments of the present invention provide a data feature determining method and apparatus, and an electronic device, which are improved based on logistic regression. Firstly, a selected feature set and an excluded feature set can be set at an initial stage, which is equivalent to adding a prior feature for feature selection of a model, thereby reducing an amount of calculation for unnecessary feature selection. Secondly, a VIF measuring a correlation between features is used for feature selection. This reduces a possibility of multicollinearity between features, effectively reduces feature redundancy, and improves performance of the model in a credit and loan business. Finally, a minimum increment threshold is preset, and calculation is stopped in advance for a model that has met a performance requirement. This avoids subsequent meaningless calculation of the model and reduces an amount of calculation. Compared with an original model, a model obtained through training based on final data features has better performance in a credit and loan business scenario, requires a smaller amount of calculation for feature extraction, and requires fewer features to achieve same performance because extracted features are rarely correlated, and reduces space required for data storage to a certain extent.

### BRIEF DESCRIPTION OF THE DRAWINGS

To describe the technical solutions in the embodiments of the present invention more clearly, the following briefly describes the accompanying drawings required for describing the embodiments. It should be understood that, the following accompanying drawings show merely some embodiments of the present invention, and therefore should not be regarded as a limitation on the scope. A person of ordinary skill in the art may still derive other related drawings from these accompanying drawings without creative efforts.

FIG. 1 is a flowchart of a data feature determining method according to an embodiment of the present invention;

FIG. 2 is a block diagram of modules of a data feature determining apparatus according to an embodiment of the present invention; and

FIG. 3 is a diagram of a hardware structure of an electronic device according to an embodiment of the present invention.

### DETAILED DESCRIPTION OF THE EMBODIMENTS

For the sake of a better understanding of the above technical solutions, the technical solutions in the present invention are described in detail with reference to the accompanying drawings and specific embodiments. It should be understood that the embodiments in the present invention and specific features in the embodiments are detailed descriptions of the technical solutions in the present invention, and are not intended to limit the technical solutions in the present invention. The embodiments in the present invention and technical features in the embodiments may be combined with each other in a non-conflicting situation.

After research and analysis, the inventor finds that forward feature selection generally includes the following steps:

1. An electronic device reads a related user data set from a document or a database.

2. Initialize an empty set as a selected feature set, and use, as a candidate feature set, a set including all features in the data set.

3. Traverse the candidate feature set, select one feature from the candidate features each time and combine the feature and the selected feature set, train a model, evaluate an effect of the model, and record a model evaluation indicator corresponding to the feature.

4. Select, from the candidate features, a feature that makes model performance best, add the feature to the selected feature set, and delete the feature from the candidate feature set.

5. Repeat 3 and 4, stop iteration when a quantity of features in the selected feature set reaches a preset maximum feature quantity, and use all the features in the selected feature set as features finally selected by the model.

Logistic regression-based backward feature selection is similar to forward feature selection, and generally includes the following steps:

1. An electronic device reads a related user data set from a document or a database.

2. Initialize an empty set as a deleted feature set, and use, as a to-be-deleted feature set, a set including all features in the data set.

3. Traverse the to-be deleted feature set, select one feature from the set each time, and train a model by using all features, excluding the feature, in the to-be-deleted set, evaluate an effect of the model, and record a model evaluation indicator corresponding to the feature.

4. Delete a feature that makes model performance best from the to-be-deleted feature set.

5. Repeat 3 and 4, stop iteration when a quantity of features in the to-be-deleted feature set reaches a preset maximum feature quantity, and use all the features in the to-be-deleted feature set as features finally selected by the model.

However, for logistic regression-based forward feature selection, all remaining features need to be combined with a selected feature one by one to train a model in each round, resulting in high time complexity in calculation. In addition, an added feature may be related to some of the selected features, forming multicollinearity. This results in feature redundancy. Disadvantages of backward feature selection are basically the same as those of forward feature selection.

Therefore, the present invention improves logistic regression-based forward feature selection, sets an initial selected feature set and an initial excluded feature set, and selects features of the model based on a VIF that measures a correlation between a variance of a feature and a variance of another feature, thereby reducing a possibility of feature correlation.

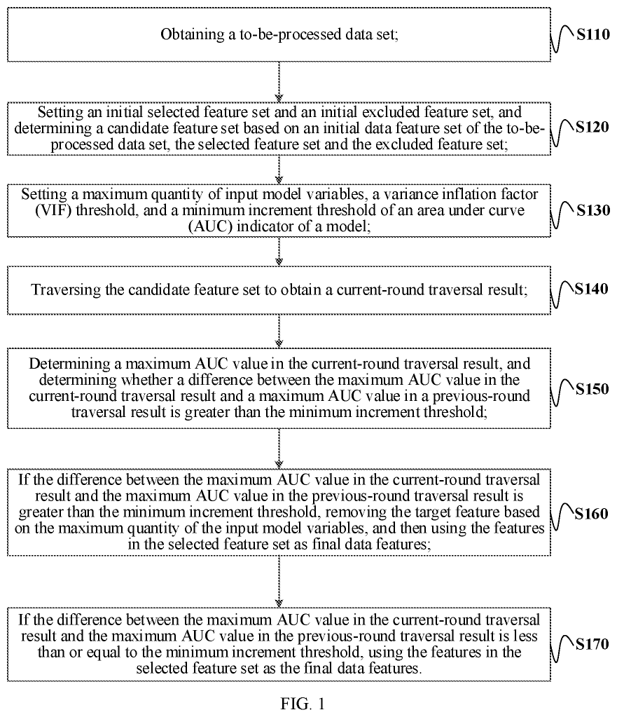

FIG. 1 shows a data feature determining method. The method is applied to an electronic device, and includes the following steps S110 to S170.

Step S110: Obtain a to-be-processed data set.

Step S120: Set an initial selected feature set and an initial excluded feature set, and determine a candidate feature set based on an initial data feature set of the to-be-processed data set, the selected feature set and the excluded feature set.

In this embodiment, the selected feature set and the excluded feature set are relative. The selected feature set may be selected based on an actual business situation. Similarly, the excluded feature set may also be excluded based on the actual business situation. Further, the selected feature set and the excluded feature set may be understood as determined feature sets. In this embodiment, the selected feature set and the excluded feature set may be data feature sets for the credit and loan business field, such as identity characteristics and loan behavior features. This is not limited herein.

Step S130: Set a maximum quantity of input model variables, a VIF threshold, and a minimum increment threshold of an AUC indicator of a model.

Step S140: Traverse the candidate feature set to obtain a current-round traversal result.

Step S150: Determine a maximum AUC value in the current-round traversal result, and determine whether a difference between the maximum AUC value in the current-round traversal result and a maximum AUC value in a previous-round traversal result is greater than the minimum increment threshold.

Step S160: If the difference between the maximum AUC value in the current-round traversal result and the maximum AUC value in the previous-round traversal result is greater than the minimum increment threshold, add a target feature corresponding to the maximum AUC value in the current-round traversal result to the selected feature set and remove the target feature from the candidate feature set; return to traverse the candidate feature set to obtain the current-round traversal result until a quantity of features in the selected feature set reaches the maximum quantity of the input model variables; and then use the features in the selected feature set as final data features.

Step S170: If the difference between the maximum AUC value in the current-round traversal result and the maximum AUC value in the previous-round traversal result is less than or equal to the minimum increment threshold, use the features in the selected feature set as the final data features.

For ease of understanding, a specific example is used for description below.

Step 1: An electronic device obtains a data set with a binary classification label from text or a database. The binary classification label is divided into a positive example and a counter example. For example, in loan data, label 1 is used to represent that a loan is not approved, in other words, the positive example, and label 0 is used to represent that the loan is approved, in other words, the counter example.

Step 2: Set an initial selected feature set S and an initial excluded feature set O, and calculate, based on a set A constituted by all features in the data set, a candidate feature set C according to the following formula: C=A−S−O.

Step 3: Set a maximum quantity of input model variables (n_features), a VIF threshold (vif_threshold), and a minimum increment threshold of an AUC indicator of a model (min_increase).

Step 4: Traverse the candidate feature set C, select a feature F each time and combine the feature F and the selected feature set S to construct a logistic regression model, perform five-fold cross validation on the data set by using the model, and record an average AUC value avg_auc and a maximum VIF value max_vif that correspond to the feature F in five cross validations performed by using the model. If max_vif of the feature F is greater than the preset threshold vif_threshold, it is regarded that multicollinearity exists between the feature and some features in the selected feature set S, and feature redundancy is caused if the feature is added to the selected feature set S. Therefore, the feature is deleted from the candidate feature set and does not participate in a subsequent iteration.

Step 5: Find a maximum value of avg_auc of all candidate features traversed in the current round, and donate the maximum value as max_AUC, and if a difference between the current-round max_auc and a previous-round max_auc is greater than min_increase, add a feature corresponding to the current-round max_auc to the selected feature set S, and remove the feature from the candidate feature set C; if a difference between the current-round max_auc and a previous-round max_auc is less than min_increase, stop iteration in advance, skip step 6 and perform step 7, and use features in the selected feature set S as features finally selected by the model.

Step 6: Repeat steps 4 and 5, stop iteration when a quantity of features in the selected feature set S reaches the preset n_features, and use all the features in the selected feature set S as features finally selected by the model.

Step 7: Input the selected features into another model of a credit and loan business for training and prediction.

It can be understood that, based on above content, firstly, the selected feature set and the excluded feature set can be set at an initial stage, which is equivalent to adding a prior feature for feature selection of the model, thereby reducing an amount of calculation for unnecessary feature selection. Secondly, a VIF measuring a correlation between features is used for feature selection. This reduces a possibility of multicollinearity between features, effectively reduces feature redundancy, and improves performance of the model in the credit and loan business. Finally, the minimum increment threshold is preset, and calculation is stopped in advance for a model that has met a performance requirement. This avoids subsequent meaningless calculation of the model and reduces an amount of calculation. Compared with an original model, a model obtained through training based on final data features has better performance in a credit and loan business scenario, requires a smaller amount of calculation for feature extraction, and requires fewer features to achieve same performance because extracted features are rarely correlated, and reduces space required for data storage to a certain extent.

Optionally, the method further includes: training and predicting a target model by using the final data features.

Optionally, the step of determining the candidate feature set based on the initial data feature set of the to-be-processed data set, the selected feature set and the excluded feature set includes: deleting the selected feature set and the excluded feature set from the initial data feature set to obtain the candidate feature set.

Optionally, the step of traversing the candidate feature set to obtain the current-round traversal result includes: selecting one to-be-processed feature from the candidate feature set each time, combining the to-be-processed feature and the selected feature set, and constructing a logistic regression model; performing five-fold cross validation on the initial data feature set by using the logistic regression model, and recording an average AUC value and a maximum VIF value that correspond to the to-be-processed feature in five cross validations performed by using the constructed logistic regression model; if the maximum VIF value corresponding to the to-be-processed feature is greater than the VIF threshold, deleting the to-be-processed feature from the candidate feature set; and if the maximum VIF value corresponding to the to-be-processed feature is less than or equal to the VIF threshold, retaining the to-be-processed feature.

Based on the above same inventive concept, a data feature determining apparatus 200 is provided, as shown in FIG. 2. The apparatus is applied to an electronic device, and includes following modules:

a data acquisition module 210, configured to obtain a to-be-processed data set;

a feature determining module 220, configured to set an initial selected feature set and an initial excluded feature set, and determine a candidate feature set based on an initial data feature set of the to-be-processed data set, the selected feature set and the excluded feature set;

a variable setting module 230, configured to set a maximum quantity of input model variables, a VIF threshold, and a minimum increment threshold of an AUC indicator of a model;

a feature traversal module 240, configured to traverse the candidate feature set to obtain a current-round traversal result; and

a feature selection module 250, configured to: determine a maximum AUC value in the current-round traversal result, and determine whether a difference between the maximum AUC value in the current-round traversal result and a maximum AUC value in a previous-round traversal result is greater than the minimum increment threshold;

if the difference between the maximum AUC value in the current-round traversal result and the maximum AUC value in the previous-round traversal result is greater than the minimum increment threshold, add a target feature corresponding to the maximum AUC value in the current-round traversal result to the selected feature set and remove the target feature from the candidate feature set; return to traverse the candidate feature set to obtain the current-round traversal result until a quantity of features in the selected feature set reaches the maximum quantity of the input model variables; and then use the features in the selected feature set as final data features; and

if the difference between the maximum AUC value in the current-round traversal result and the maximum AUC value in the previous-round traversal result is less than or equal to the minimum increment threshold, use the features in the selected feature set as the final data features.

Optionally, the apparatus further includes: a model training module 260, configured to train and predict a target model by using the final data features.

Optionally, when the feature determining module 220 determines the candidate feature set based on the initial data feature set of the to-be-processed data set, the selected feature set and the excluded feature set, the feature determining module 220 is specifically configured to: delete the selected feature set and the excluded feature set from the initial data feature set to obtain the candidate feature set.

Optionally, when the feature traversal module 240 traverses the candidate feature set to obtain the current-round traversal result, the feature traversal module 240 is specifically configured to: select one to-be-processed feature from the candidate feature set each time, combine the to-be-processed feature and the selected feature set, and construct a logistic regression model; perform five-fold cross validation on the initial data feature set by using the logistic regression model, and record an average AUC value and a maximum VIF value that correspond to the to-be-processed feature in five cross validations performed by using the constructed logistic regression model; if the maximum VIF value corresponding to the to-be-processed feature is greater than the VIF threshold, delete the to-be-processed feature from the candidate feature set; and if the maximum VIF value corresponding to the to-be-processed feature is less than or equal to the VIF threshold, retain the to-be-processed feature.

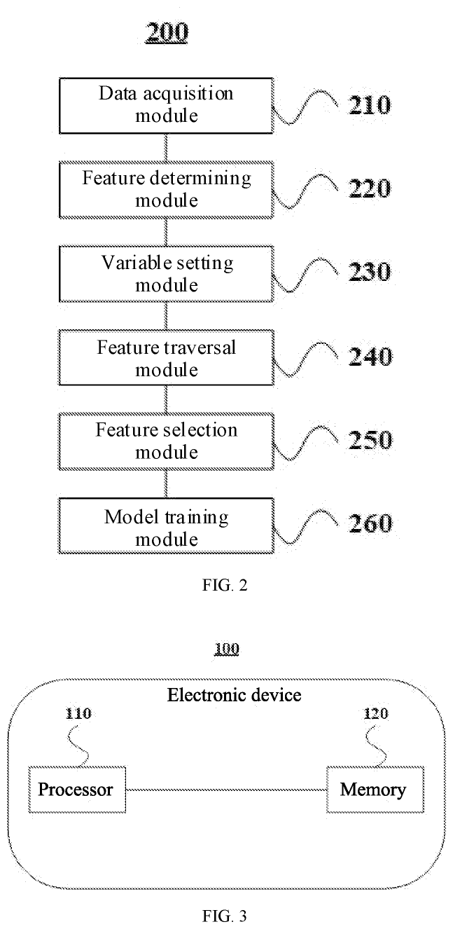

Based on the above descriptions, as shown in FIG. 3, an electronic device 100 is provided, including a processor 110 and a memory 120 that communicate with each other, where the processor 110 is configured to obtain a computer program from the memory 120, and run the computer program to implement the above method.

Based on the above descriptions, a computer-readable storage medium is provided. The computer-readable storage medium stores a computer program, and the computer program implements the above method during running.

To sum up, the embodiments of the present invention provide a data feature determining method and apparatus, and an electronic device, which are improved based on logistic regression. Firstly, a selected feature set and an excluded feature set can be set at an initial stage, which is equivalent to adding a prior feature for feature selection of a model, thereby reducing an amount of calculation for unnecessary feature selection. Secondly, a VIF measuring a correlation between features is used for feature selection. This reduces a possibility of multicollinearity between features, effectively reduces feature redundancy, and improves performance of the model in a credit and loan business. Finally, a minimum increment threshold is preset, and calculation is stopped in advance for a model that has met a performance requirement. This avoids subsequent meaningless calculation of the model and reduces an amount of calculation. Compared with an original model, a model obtained through training based on final data features has better performance in a credit and loan business scenario, requires a smaller amount of calculation for feature extraction, and requires fewer features to achieve same performance because extracted features are rarely correlated, and reduces space required for data storage to a certain extent.

Described above are merely embodiments of the present invention, and are not intended to limit the present invention. Various changes and modifications can be made to the present invention by those skilled in the art. Any modifications, equivalent replacements, improvements, etc. made within the spirit and principle of the present invention should be included within the protection scope of the claims of the present invention.

What is claimed is:

1. A data feature determining method in a credit and loan business comprises:
obtaining, by an electronic device, a to-be-processed feature set;
setting, by the electronic device based on a prior model, a first subset of the to-be-processed feature set as an initial selected feature set, a second subset of the to-be-processed feature set non-overlapping with the first subset as an initial excluded feature set, and the rest of the to-be-processed feature set as a candidate feature set;
setting, by the electronic device, a maximum quantity of input model variables, a variance inflation factor (VIF) threshold, and a minimum increment threshold of an area under curve (AUC) indicator of a model;
traversing, by the electronic device, the candidate feature set to obtain a current-round traversal result;
determining, by the electronic device, a maximum AUC value in the current-round traversal result; determining, by the electronic device, whether a difference between the maximum AUC value in the current-round traversal result and a maximum AUC value in a previous-round traversal result is greater than the minimum increment threshold;
when the difference between the maximum AUC value in the current-round traversal result and the maximum AUC value in the previous-round traversal result is greater than the minimum increment threshold: adding a target feature corresponding to the maximum AUC value in the current-round traversal result to the selected feature set and removing the target feature from the candidate feature set; returning to the step of traversing the candidate feature set to obtain the current-round traversal result until a quantity of features in the selected feature set reaches the maximum quantity of the input model variables; and using the features in the selected feature set as final data features;
when the difference between the maximum AUC value in the current-round traversal result and the maximum AUC value in the previous-round traversal result is less than or equal to the minimum increment threshold, using the features in the selected feature set as the final data features; and
training and predicting, by the electronic device, a credit and loan target model by using the final data features;
wherein the step of traversing the candidate feature set to obtain the current-round traversal result comprises:
selecting one to-be-processed feature from the candidate feature set each time, combining the to-be-processed feature and the selected feature set, and constructing a logistic regression model;
performing five-fold cross validation on the initial data feature set by using the constructed logistic regression model, and recording an average AUC value and a maximum VIF value that correspond to the to-be-processed feature in five cross validations performed by using the constructed logistic regression model;
when the maximum VIF value corresponding to the to-be-processed feature is greater than the VIF threshold, deleting the to-be-processed feature from the candidate feature set; and
when the maximum VIF value corresponding to the to-be-processed feature is less than or equal to the VIF threshold, retaining the to-be-processed feature.

2. (canceled)

3. (canceled)

4. A data feature determining apparatus in a credit and loan business, wherein the apparatus includes a processor, a memory, and instructions stored in the memory, and when the instructions are executed by the processor, cause the apparatus to:
obtain a to-be-processed feature set;
based on a prior model, set a first subset of the to-be-processed feature set as an initial selected feature set, a second subset of the to-be-processed feature set non-overlapping with the first subset as an initial excluded feature set, and the rest of the to-be-processed feature set as a candidate feature set;
set a maximum quantity of input model variables, a variance inflation factor (VIF) threshold, and a minimum increment threshold of an area under curve (AUC) indicator of a model;
traverse the candidate feature set to obtain a current-round traversal result; and
determine a maximum AUC value in the current-round traversal result; determine whether a difference between the maximum AUC value in the current-round traversal result and a maximum AUC value in a previous-round traversal result is greater than the minimum increment threshold;
when the difference between the maximum AUC value in the current-round traversal result and the maximum AUC value in the previous-round traversal result is greater than the minimum increment threshold: add a target feature corresponding to the maximum AUC value in the current-round traversal result to the selected feature set and remove the target feature from the candidate feature set; return to traverse the candidate feature set to obtain the current-round traversal result until a quantity of features in the selected feature set reaches the maximum quantity of the input model variables; and use the features in the selected feature set as final data features;
when the difference between the maximum AUC value in the current-round traversal result and the maximum AUC value in the previous-round traversal result is less than or equal to the minimum increment threshold, use the features in the selected feature set as the final data features; and
train and predict a credit and loan target model by using the final data features;
wherein traverses the candidate feature set to obtain the current-round traversal result further comprises:
select one to-be-processed feature from the candidate feature set each time, combine the to-be-processed feature and the selected feature set, and construct a logistic regression model;
perform five-fold cross validation on the initial data feature set by using the constructed logistic regression model, and record an average AUC value and a maximum VIF value that correspond to the to-be-processed feature in five cross validations performed by using the logistic regression model;
when the maximum VIF value corresponding to the to-be-processed feature is greater than the VIF threshold, delete the to-be-processed feature from the candidate feature set; and
when the maximum VIF value corresponding to the to-be-processed feature is less than or equal to the VIF threshold, retain the to-be-processed feature.

5. (canceled)

6. (canceled)

7. (canceled)

8. A non-transitory computer-readable storage medium, wherein a computer program is stored on the non-transitory computer-readable storage medium, and the computer program is configured to be run by a processor to implement the data feature determining method in a credit and loan business according to claim 1.

9. (canceled)

10. (canceled)

11. (canceled)

12. (canceled)
